(19) United States
(12) Patent Application Publication
(10) Pub. No.: US 2009/0063464 A1
(43) Pub. Date: Mar. 5, 2009

(54) System and method for visualizing and relevance tuning search engine ranking functions

(76) Inventors: Chi-Chao Chang, Santa Clara, CA (US); Rajesh Krishna Shenoy, San Jose, CA (US)

Correspondence Address: YAHOO! INC.;C/O Ostrow, Kaufman & Frankl LLP, 136 E. 57th Street, 12th Floor, NEW YORK, NY, 10022, US

(21) Appl. No.: 11/897,300

(22) Filed: Aug. 29, 2007

(51) Int. Cl. G06F 7/06

(52) U.S. Cl. 707/5; 707/E17.014

(57) ABSTRACT

The present invention is directed towards system and methods for generating a visual representation indicating performance of a system capable of accepting one or more inputs and producing an ordered set of one or more responsive outputs. The method of the present invention comprises selecting one or more benchmark inputs and generating an ordered output set for each of the one or more benchmark inputs, a given output set comprising one or more output items responsive to a given benchmark query. One or pixels representing the one or more output items comprising the one or more outputs sets are generated, a given pixel containing a visual representation indicating a degree to which the output item represented by the pixel is relevant with respect to the benchmark input to which the output item is responsive. The one or more pixels representing the one or more output items comprising the one or more output sets are arranged in a circle in a manner indicative of the performance of the system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Search engines are commonly used to search the numerous content items that may available on computer networks, such as the World Wide Web, to enable users to locate content items of interest. A typical search engine is capable of accessing the plurality of web pages, hypertext documents, images, video, audio, and other content items from the Internet or other network that may be responsive to a given Internet user's search.

To use a given search engine, a user of a client device typically enters one or more search terms or keywords comprising a query. The search engine thereafter identifies one or more content items responsive to the one or more search terms or keywords comprising a received query. The content items identified by the search engine may be combined to form a result set that is displayed to the user with which the query originated.

A search engine may rank the content items identified as responsive to a given query according to relevance in a list or other type of arrangement to allow a user of the search engine to easily ascertain the results identified by the search engine that are more likely to be responsive to the user's search. For example, a search engine may determine that a first given content item identified as responsive to a given query is more relevant than a second given content item identified as responsive to the query. Accordingly, the search engine may place the first content item in a more prominent position in a result set of responsive content items, such as at the top of a list of ranked content items, in comparison to the position at which the second content item is placed.

In order to properly rank content items that are identified as responsive to a given query, search engine operators must continually examine and refine the ranking function that a search engine utilizes to rank responsive content items. Search engine operators may be required to manually review the hundreds or thousands of content items identified as responsive to a given query in order to refine a ranking function utilized by the search engine to ensure that the search engine ranks content items appropriately. For example, search engine operators may determine that a given content item identified as responsive to a given query that is ranked in position eight (“8”) is more responsive to the query than a content item identified as responsive to the query and ranked in position three (“3”). Accordingly, the search engine operators may be required to modify the ranking function utilized by the search engine until the search engine appropriately ranks all content items identified as responsive to the query.

Current techniques for testing and refining a search engine ranking function may require a significant expenditure of time and effort in order for search engine operators to perform testing for the numerous queries that Internet users may generate. Further, search engine operators are required to review increasing amounts of content items responsive to queries as the type and quantity of content items that may be responsive to queries increases. While some search engines utilize machine learning to refine a search engine ranking function, even machine learning techniques require manual review of problematic queries and query result sets. Accordingly, there exists a need to efficiently view and refine a search engine ranking function without the need to manually review the numerous queries and content items that may be responsive to such queries. In order to overcome shortcomings associated with existing techniques for visualizing and refining a search engine ranking function, the present invention provides systems and methods for generating a visual representation of content items responsive to one or more queries that are ranked through use of a ranking function.

### SUMMARY OF THE INVENTION

The present invention is directed towards systems and methods for generating a visual representation indicating performance of a system capable of accepting one or more inputs and producing an ordered set of one or more responsive outputs. The method of the present invention comprises selecting one or more benchmark inputs. An ordered output set is generated for each of the one or more benchmark inputs, a given output set comprising one or more output items responsive to a given benchmark input. According to one embodiment of the present invention, the one or more benchmark inputs comprise benchmark queries generated by users of a search engine. An ordered output set for each of the one or more benchmark queries may be generated, a given output set comprising the one or more content items responsive to a given benchmark query, wherein a content item may comprise a web page, document, audio content, or video content.

The method of the present invention further comprises generating one or more pixels, which may comprise three dimension pixels, representing the one or more output items comprising the one or more output sets, a given pixel containing a visual representation indicating a degree to which the output item represented by the pixel is relevant with respect to the benchmark input to which the output item is responsive. A given pixel may contain a color, pattern, or symbol indicative of the degree to which the output item represented by the pixel is relevant with respect to the benchmark input to which the output item is responsive. Further, a given pixel may be of a given size or shape indicative of the degree to which the output item represented by the pixel is relevant with respect to the benchmark input to which the output item is responsive.

The one or more pixels representing the one or more output items comprising the one or more output sets are arranged in a circle in a manner indicative of the performance of the system. According to one embodiment of the present invention, the one or more output items comprising a given output set are ordered through use of a ranking function. The one or more pixels representing each of the output items are arranged on a line according to a rank associated with the one or more output items as determined by the ranking function, a given line associated with a given output set. The one or more lines are thereafter arranged in a circle, which may comprise a three dimensional circle. Further, the one or more lines may be sorted through use of a sorting algorithm.

The method of the present invention further comprises receiving an indication of a user selection of a given region in the circle and providing information regarding the selected region. According to one embodiment of the present invention, a user selection of a given region in the circle comprises a user selection of one or more pixels representing one or more output items resulting in the display of the one or more output items represented by the one or more selected pixels.

According to one embodiment, the method of the present invention further comprises arranging the one or more pixels representing the one or more output items comprising the one or more output sets in a first circle, the one or more output items in the one or more output sets ordered according to a ranking function. One or more modifications are performed with respect to the ranking function, and the one or more pixels representing the one or more output items comprising the one or more output sets are arranged in a second circle, the one or more output items in the one or more output sets ordered according to the modified ranking function. A comparison is thereafter performed between the first circle and the second circle. The modifications performed with respect to the ranking function may comprise modifying one or more ways in which the ranking function identifies a ranking for the one or more output items comprising a given output set. The comparison performed with respect to the first and second circle may comprise identifying one or more pixels that differ between the first and second circle or displaying differences between the first circle and the second circle across time in a movie.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for generating a rank circle with which content items responsive to one or more queries may be viewed, according to one embodiment of the present invention;

FIG. 2 is a flow diagram illustrating one embodiment of a method for generating and storing a rank circle, according to one embodiment of the present invention;

FIG. 3 is a flow diagram illustrating one embodiment of a method for performing a comparison between a first and second rank circle, according to one embodiment of the present invention;

FIG. 4 is a screen diagram illustrating one embodiment for visually representing the relevance of content items with respect to a query, according to one embodiment of the present invention;

FIG. 5 is a screen diagram illustrating one embodiment of a rank circle for illustrating the ranking and relevance of content items with respect to a first and second query, according to one embodiment of the present invention;

FIG. 6 is a screen diagram illustrating one embodiment of an unsorted rank circle for illustrating the relevance and rank of content items with respect to a plurality of queries, according to one embodiment of the present invention;

FIG. 7 is a screen diagram illustrating one embodiment of a sorted rank circle for illustrating the ranking and relevance of content items with respect to a plurality of queries, according to one embodiment of the present invention;

FIG. 8 is a screen diagram illustrating one embodiment of a method for calculating the precision of a ranking function using a rank circle, according to one embodiment of the present invention;

FIG. 9 is a screen diagram illustrating one embodiment for performing a comparison with respect to a first and a second rank circle, according to one embodiment of the present invention;

FIG. 10 is a screen diagram illustrating one embodiment for illustrating the differences between a first and a second rank circle, according to one embodiment of the present invention; and

FIG. 11 is a screen diagram illustrating one embodiment of a rank circle and additional information that may be presented upon selection of a given area within the rank circle, according to one embodiment of the present invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

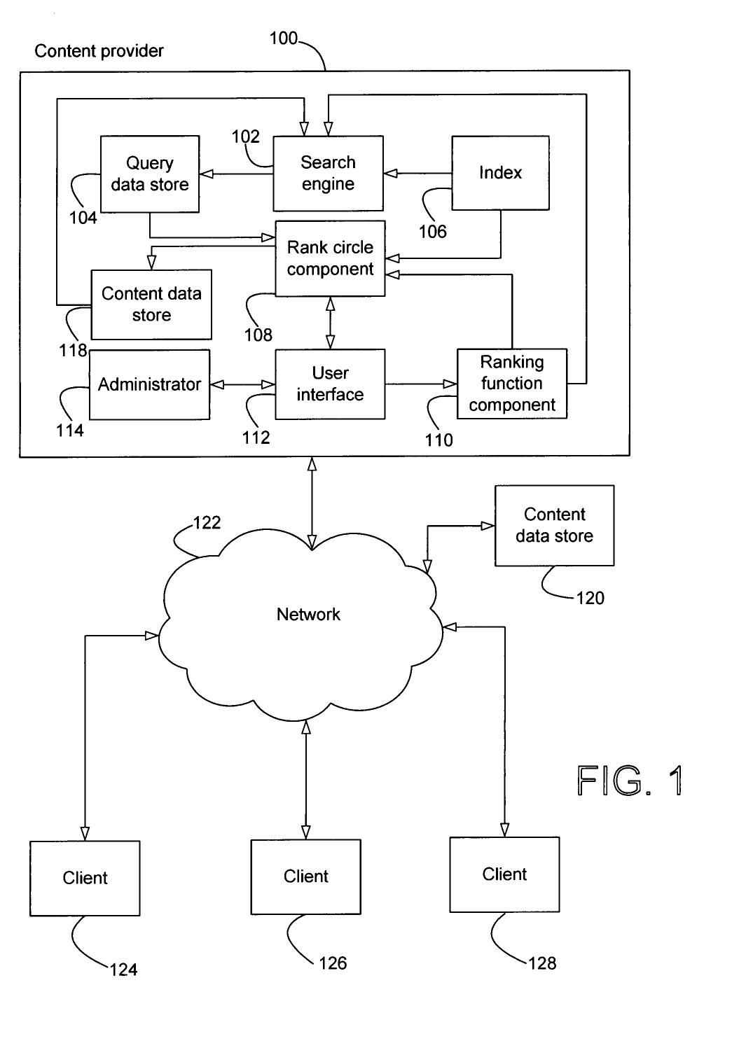

FIG. 1 presents a block diagram depicting one embodiment of a system for generating rank circles for visualizing the ranking and relevancy of one or more content items responsive to one or more queries. According to the embodiment illustrated in FIG. 1, client devices 124, 126, and 128 are communicatively coupled to a network 122, which may include a connection to one or more local and wide area networks, such as the Internet. According to one embodiment of the invention, a client device 124, 126 and 128 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A user of a client device 124, 126, and 128 communicatively coupled to the network 122 may access a variety of content available on the network 122. According to one embodiment of the invention, a user of a client device 124, 126, and 128 may transmit a search query comprising one or more terms to a content provider 100 coupled to the network 122. A typical query received by the content provider 100 from a user of a client device 124, 126, and 128 has one or more terms. For example, the query “wireless notebook computer” contains three terms and may be referred to as a three-term query. Similarly, queries containing only one term are referred to as one-term queries, queries containing two terms are two-term queries, etc. A space or other delimiter character may used to identify the individual terms comprising a given query.

A search engine 102 at the content provider 102 may utilize the one or more terms comprising a given query to identify content, such as web pages, video clips, audio clips, documents, etc., that are responsive to the one or more terms comprising the query. The search engine 102 may search an index 106 of content items that are available on the network 122. According to one embodiment of the present invention, the index 106 comprises a list of word location pairs that, given a keyword, is correlated with one or more content items associated with the keyword that are maintained in one or more local or remote content data stores 118 and 120. The index 106 may comprise additional information regarding a given content item that includes, but is not limited to, features of a given content item, title, description, inbound links, outbound links, etc.

The search engine 102 identifies one or more content items responsive to a given query received from a client device 124, 126, and 128 and generates a result set comprising the one or more content items. According to one embodiment of the present invention, the search engine 102 utilizes a ranking function component 110, which maintains a ranking function, for identifying a ranking of the one or more content items comprising a result set responsive to a given query. A given ranking function maintained by the ranking function component 110 that is utilized by the search engine 102 may rank one or more content items responsive to a given query based upon one or more features. According to one embodiment of the present invention, a feature comprises a characteristic of a given content item that may be used to identify the extent to which a content item matches or is similar to a given query. For example, a feature of a given content item may comprise one or more terms that appear in the content item. The terms appearing in the content item may be used to determine the extent to which the one or more terms match or are similar to the one or more terms comprising a given query. Similarly, a feature of a given content item may comprise a category to which the content item belongs, such as “audio content item,” “video content item,” or “textual content item.” The category to which a given content item belongs may be used to determine the extent to which the content item matches or is similar with respect to a given query.

The ranked result set identified as responsive to the received query may be presented to the user of the client device 124, 126, and 128 with which the query originated. Additionally, the search engine 102 may store the query received from a given client 124, 126, and 128. The query data store may comprise an accessible memory structure such as a database, CD-ROM, tape, digital storage library, etc., and may be implemented as a database, file system, or any other type of storage structures capable of providing for the retrieval and storage of a variety of content.

A content provider administrator 114 may generate a rank circle providing a visualization of the one or more queries generated by users of client devices 124, 126, and 128, as well as the one or more content items that may displayed in response to such queries. A rank circle further indicates the relevance of each respective content item, as well as the rank at which each content item is displayed in a ranked result set, as determined by the ranking function maintained by the ranking function component 110 and utilized by the search engine 102 to rank one or more content items responsive to a given query.

According to the embodiment illustrated in FIG. 1, an administrator 114 accesses a rank circle component 108 at the content provider 100 via a user interface 112. The user interface 112 may require the administrator 114 to provide various information, including, but not limited to, a username and password in order to allow the administrator to access the rank circle component 108.

The administrator 114 may deliver a request to the rank circle component 108 to generate a rank circle in order to provide a visualization of the one or more queries generated by users of client devices 124, 126, and 128, the one or more content items that are displayed in response to the one or more queries, the rank at which the content items may be displayed, and the relevance of each content item with respect to a given query. According to one embodiment of the present invention, in response to a request from the administrator 114, the rank circle component 108 retrieves the one or more queries generated by users of client devices 124, 126, and 128 from the query data store 104, or a subset of the one or more queries generated by users of client devices 124, 126, and 128. For example, the rank circle component 108 may retrieve a predetermined number of queries, such as one hundred (“100”) queries, from the query data store 104.

In addition to retrieving one or more queries, the rank circle component retrieves the ranking function maintained by the ranking function component 110, and utilized by the search engine 102 to rank one or more content items in a result set responsive to a given query received from a user of a client device 124, 126, and 128. The rank circle component 108 thereafter utilizes the abovementioned index 106 to identify the one or more content items responsive to each query retrieved from the query data store 104. For example, the rank circle component 108 may utilize the abovementioned word location index to identify and retrieve content items maintained in one or more remote 120 or local 118 content data stores, and retrieve the one or more identified content items. The rank circle component 108 may thereafter utilize the ranking function retrieved from the ranking function component 110 to rank the one or more retrieved content items.

The rank circle component 108 thereafter generates a rank circle, which provides a visualization of the one or more content items responsive to a given query, the rank of the one or more content items, and the relevancy of each content item with respect to a given query. According to one embodiment of the present invention, each content item selected as responsive to a given query is represented on the rank circle as a pixel. The pixel representing a given content item selected as responsive to a given query at a particular rank contains an indication of the relevance of the content item with respect to the query in response to which the content item was selected.

According to one embodiment of the present invention, the pixel representing a given content item may contain a color, which indicates to the degree to which the content item is relevant with respect to the query in response to which the content item was selected. For example, a “Green” pixel representing a given content item selected as responsive to a given query may indicate that the content item is “Relevant” with respect to the query, whereas a “Yellow” pixel representing a given content item selected as responsive to a given query may indicate that the content item is “Not Relevant” with respect to the query.

According to another embodiment of the present invention, a pixel may contain a pattern or symbol, indicating the degree to which the content item is relevant with respect to a query in response to which the content item was selected. Those of skill in the art recognize the plurality of techniques that may be used to indicate the relevance of a given content item with respect to a given query using a visual representation.

According to one embodiment of the present invention, the color, symbol, pattern, etc., assigned to a given pixel representing a content item and indicating the degree to which the content item is relevant with respect to a given query is determined automatically by the rank circle component 108. For example, the rank circle component 108 may utilize a relevance function to determine the degree to which a given content item is relevant with respect to a given query. Based upon the relevance determination, the rank circle component 108 may assign a pixel representing the content item a color, pattern, symbol, or other visual representation indicating the degree to which the content item is relevant with respect to the query. According to another embodiment of the present invention, an administrator 114 may perform a review of the one or more queries and one or more content items displayed in response to the one or more queries, and assign a color, pattern, symbol, etc., to the pixels representing each content item indicative of the degree to which each content item is relevant with respect to the queries.

The administrator may perform various functions with respect to the rank circle generated by the rank circle component 108. According to one embodiment of the present invention, the administrator 114 may sort the one or more queries represented in a given rank circle using one or more sorting techniques. For example, the administrator 114 may sort a given rank circle along the perimeter of the rank circle. Similarly, the administrator 114 may sort a given rank circle according to the relevancy of the content items displayed in response to each respective query.

Alternatively, or in conjunction with the foregoing, the administrator 114 may perform one or more modifications to the ranking function maintained by the ranking function component 110. For example, the administrator may modify the ranking function to incorporate or exclude one or more features in determining a rank for a given content item responsive to a given query.

If the administrator 114 performs one or more modifications to the ranking function, the administrator may deliver another request to the rank circle component 108 to generate a new rank circle based upon the modified ranking function. In response to the request, the rank circle component 108 may retrieve the modified ranking function maintained by the ranking function component 110 and perform a re-ranking of the content items identified as responsive to the queries selected from the query data store 104. The rank circle component 108 may thereafter generate another rank circle. The administrator 114 may perform a comparison of the rank circles in order to determine the way in which the modifications to the ranking function maintained by the ranking function component 110 impact the rank circles generated by the rank circle component 108.

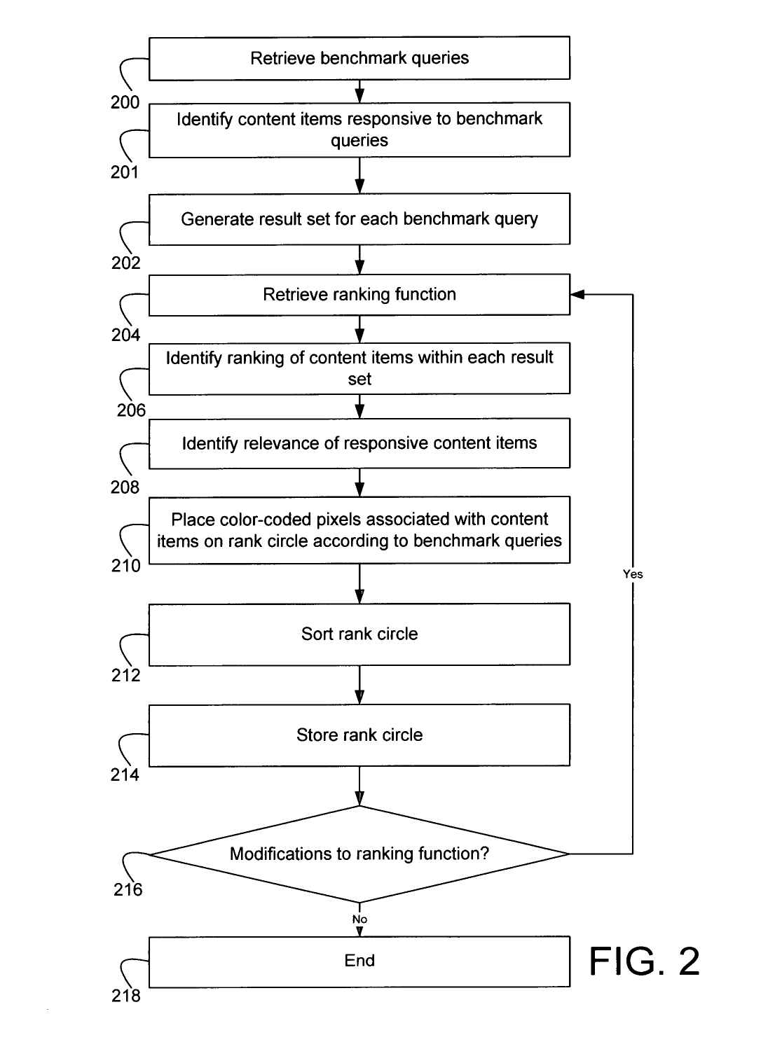

FIG. 2 illustrates one embodiment of a method for generating a rank circle providing a visualization of the relevance and rank, as determined by a ranking function, of content items responsive to a given query. According to the embodiment illustrated in FIG. 2, one or more benchmark queries are retrieved, wherein the retrieved benchmark queries may comprise one or more queries generated by users of a search engine, or a subset thereof, step 200.

A search is performed to identify the one or more content items responsive to the retrieved benchmark queries, step 201. The one or more content items identified as responsive to the one or more retrieved benchmark queries may comprise a plurality of types of content items, including, but not limited to, audio content items, video content items, and document content items, such as web pages.

A result set is generated for each benchmark query retrieved, step 202. For example, the one or more content items identified as responsive to a given benchmark query may comprise the result set responsive to the benchmark query.

A ranking function is retrieved, step 204. According to one embodiment of the present invention, a ranking function comprises a function that may be used to identify the ranking of a given content item, such as a document, video clip, audio clip, etc., in a result set of one or more content items identified as responsive to a given query. A ranking function may utilize one or more features associated with a given query and content item in order to determine the ranking of the content item with respect to one or more content items in a result set responsive to the query.

The retrieved ranking function is used to identify a ranking for the one or more content items comprising the one or more result sets identified as responsive to the one or more retrieved benchmark queries, step 206. For example, a given result set comprising one hundred (“100”) content items identified as responsive to a given benchmark query may be ranked utilizing the retrieved ranking function. Accordingly, each content item within the result set may be annotated with a numerical value indicating the ranking of each respective content item with the result set.

According to one embodiment of the present invention, the one or more content items with a rank exceeding a given threshold are removed from the result set associated with a given benchmark query. For example, content items in a given result set with a rank exceeding the value twenty (“20”) may be removed from the result set.

The relevance of each content item within each result set associated with each benchmark query is thereafter identified, step 208. According to one embodiment of the present invention, the relevance of a given content item with respect to a given query is determined using a relevance function. According to another embodiment of the present invention, the relevance of a given content item with respect to a given query is determined by a human editor.

According to the embodiment illustrated in FIG. 2, colored pixels representing the content items comprising the one or more result sets responsive to the benchmark queries are placed on a rank circle. According to one embodiment of the present invention, the color of a given pixel representing a given content item from a result set responsive to a given benchmark query is indicative of the relevance of the content item with respect to the query. For example, a given content item that is identified by the abovementioned relevance function or human editor as “Not Relevant” may be represented by a red pixel. Similarly, a given content item that is identified by the abovementioned relevance function or human editor as “Relevant” may be represented by a green pixel.

According to one embodiment of the present invention, varying degrees of color may be used to indicate the varying degrees of relevance of a given content item with respect to a given query. For example, a continuum of colors representing varying degrees of relevance may be used to identify the degree to which one or more content items are relevant with respect to one or more queries. According to another embodiment of the present invention, pixels representing content items may contain patterns, symbols or similar visual representations of the degrees to which content items are relevant with respect to one or more queries. Those of skill in the art recognize the plurality of techniques that may be used to provide a visual representation of the relevance of a given content item with respect to a given query.

The pixels representing the one or more content items are placed on a rank circle according to the query in response to which the content items were selected, as well as the rank of each respective content item, step 210. For example, as previously described, the one or more content items comprising the result set responsive to a given benchmark query are ranked through use of the retrieved ranking function. Pixels representing the one or more content items in the result set may be placed linearly on the rank circle, with the pixel representing the content item with the greatest rank (e.g., rank twenty (“20”)) at the center of the rank circle, and the pixel representing the content item with the lowest or most prominent rank (e.g., rank one (“1”)) at the outermost perimeter of the rank circle.

According to the embodiment illustrated in FIG. 2, the rank circle may thereafter be sorted, step 212. One or more sorting techniques may be used to sort the plurality of queries, and the pixels representing content items selected in response to the queries, in a given rank circle. For example, the one or more queries with relevant content items, which are represented by colored pixels, above a given rank may grouped together within the rank circle. Alternatively, or in conjunction with the foregoing, the one or more queries, and the pixels representing content items selected in response to the queries, may be sorted based upon both relevance and descending rank. For example, the rank circle may first be sorted based upon the one or more queries with relevant content items at rank one (“1”). The rank circle may then be sorted based upon the one or more queries with relevant content items at rank two (“2”). The sorting of each rank may continue until all ranks have been sorted within the rank circle for the one or more queries.

The sorted rank circle, sorted according to one or more sorting techniques, is thereafter stored, such as in the memory of a given computer, a database, or any similar storage structure capable of providing for the retrieval and storage of a rank circle, step 214. A check is thereafter performed to determine whether one or more modifications have been made to the ranking function with which the one or more content items comprising a result set responsive to a given benchmark query are ranked, step 216.

If no modifications to the rank circle have been made, processing terminates. In contrast, if one or more modifications have been made to the ranking function, processing returns to step 204. The modified ranking function is thereafter used to identify a ranking of content items within each result set. The relevance of the one or more content items comprising each result set, ranked according to the modified ranking function, may then be used to generate a modified rank circle.

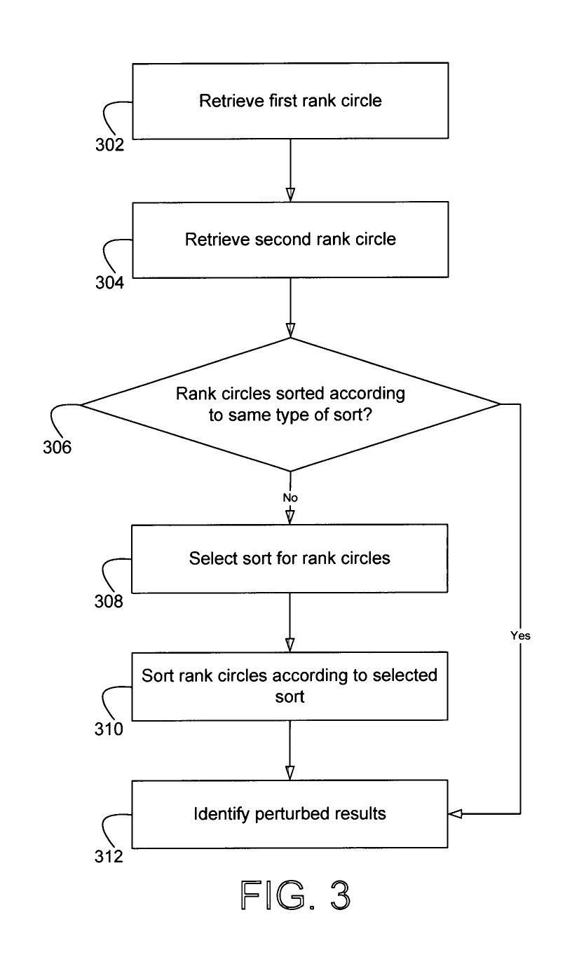

FIG. 3 is a flow diagram illustrating one embodiment of a method for performing a comparison between a first rank circle in which content items are ranked according to a ranking function, and a second rank circle in which content items are ranked according to a modified version of the ranking function. According to the embodiment illustrated in FIG. 3, a first rank circle is retrieved, step 302. The rank circle retrieved in step 302 may comprise a rank circle in which the content items, represented by pixels in the rank circle, are ranked according to a ranking function. A second rank circle is retrieved, which may comprise a rank circle in which the content items, represented by pixels in the rank circle, are ranked according to a modified version of the ranking function, step 304.

A check is performed to determine whether or not the first and second retrieved rank circles are sorted according to the same type of sorting technique, step 306. For example, the first retrieved rank circle may be sorted according to relevance and descending rank, wherein the queries represented in the rank circle are sorted based upon the relevance of each content item at each respective rank. Similarly, the second retrieved rank circle may be sorted according to the number of terms comprising each query represented in the rank circle.

If the first and second retrieved rank circles are not sorted according to a common sorting technique, a sorting technique is selected, step 308. The sorting technique selected in step 308 to sort the first and second retrieved rank circles may comprise any sorting technique that may be used with respect to a given rank circle, including, but not limited to, query length, relevance at descending rank, etc. The sorting technique may comprise a sorting technique selected by a human editor, a predetermined sorting technique, or a sorting technique selected based upon the types of queries represented in each retrieved rank circle.

The first and second retrieved rank circles are thereafter sorted according to the selected sorting technique, step 310. The resulting rank circles may thereafter be compared in order to identify perturbed results, which comprise one or more differences between the rank circles resulting from the use of an original and modified version of a ranking function, step 312.

As previously described, the pixels representing content items in a given rank circle may be colored or may contain patterns, symbols, or other visual representations indicating the relevance of each content item with respect to a given query. Accordingly, the differences between a first rank circle, in which content items are ranked according to a ranking function, and a second rank circle, in which content items are ranked according to a modified version of the ranking function, may be easily identified. For example, a human editor may simply visually inspect a first and second rank circle to identify perturbed results.

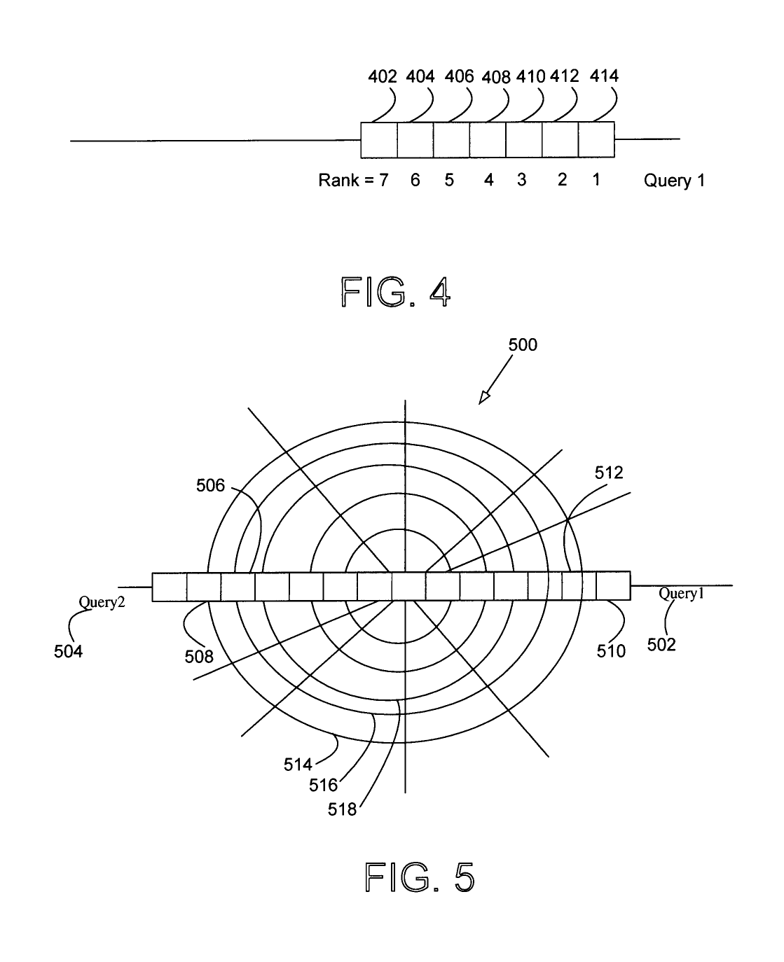

FIG. 4 is a screen diagram illustrating one embodiment of a query, and content items responsive to the query that are represented by colored pixels indicating the relevance of each respective content item with respect to the query. According to the embodiment illustrated in FIG. 4, content items are represented by colored pixels 402, 404, 406, 408, 410, 412, and 414. Each respective content item represented by a pixel is associated with a “Rank.” For example, the content item represented by pixel 402 is ranked “7,” content item represented by pixel 404 is ranked “6,” content item represented by pixel 406 is ranked “5,” content item represented by pixel 408 is ranked “4,” content item represented by pixel 410 is ranked “3,” content item represented by pixel 412 is ranked “2,” and content item represented by pixel 414 is ranked “1.” As previously described, the rank of each content item may be determined through use of a ranking function.

The screen diagram illustrated in FIG. 4 contains pixels that are colored either red or green. According to the embodiment illustrated in FIG. 4, a green pixel represents a content item that is considered relevant with respect to “Query 1,” whereas a red pixel represents a content item that is considered irrelevant with respect “Query 1.” For example, pixels 402, 410, and 412 represent content items that are considered irrelevant with respect to “Query 1,” whereas pixels 404, 406, 408, and 414 represent content items that are considered relevant with respect to “Query 1.” As previously described, the relevance of a given content item, and accordingly the color of a pixel representing the content item, may be determined by a relevance function, by a human editor, or other techniques known in the art for ascertaining the relevance of a given content item with respect to a given query.

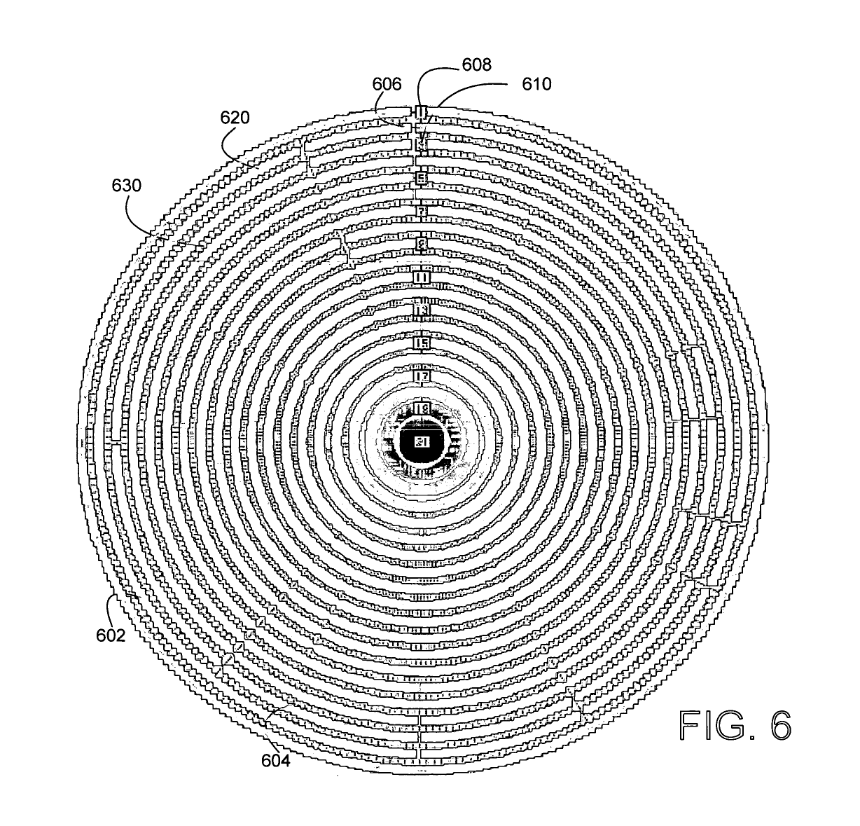

FIG. 5 is a screen diagram illustrating one embodiment of a rank circle in which pixels, representing content items, are displayed in a rank circle according to rank and relevance. According to the embodiment illustrated in FIG. 5, pixels representing content items responsive to queries “Query 1” 502 and “Query 2” 504 are placed on the rank circle 500 at the respective rank of each content item. For example, pixels 510 and 512, which represent content items responsive to “Query 1” 502, are placed on the rank circle in a position corresponding to the ranking of the content items with which they are associated.

As illustrated in FIG. 5, pixels 510 and 512, which represent content items responsive to “Query 1” 502, and pixels 508 and 506, which represent content items responsive to “Query 2” 504, are intersected by one or more circles comprising the rank circle. For example, pixels 510 and 508 are intersected by circle 514. Similarly, pixel 512 and 506 are intersected by circle 516.

The circles 514, 416, and 518 of the rank circle intersecting one or more pixels indicate the rank of the content items with which the pixels are associated. For example, as previously described, pixels 510 and 508 are intersected by circle 514, which is the outermost circle comprising the rank circle. Accordingly, pixels 510 and 508 represent content items that are ranked first in the result set of content items responsive to queries “Query 1” 502 and “Query 2,” 504 respectively. Similarly, pixels 512 and 506 are intersected by circle 516, which is the second outermost circle comprising the rank circle. Accordingly, pixels 512 and 506 represent content items that are ranked second in the result set of content items responsive to queries “Query 1” 502 and “Query 2,” 504 respectively.

Additionally, pixels 506, 508, 510, and 512 representing content items on the rank circle 500 are colored. The color of each pixel, as previously described, provides an indication of the relevance of the content item with respect to a given query. For example, pixels 512 and 508 are colored red, which according to the embodiment illustrated in FIG. 5, indicates that the content items represented by the pixels are not relevant with respect to queries “Query 1” 502 and “Query 2,” 504 respectively. Similarly, pixels 510 and 506 are green, which according to the embodiment illustrated in FIG. 5, indicates that the content items represented by the pixels are relevant with respect to queries “Query 1” 502 and “Query 2,” 504 respectively.

As illustrated in FIG. 5, a human editor can easily ascertain the rank of content items that are considered relevant with respect to one or more queries, as well as the rank of each relevant content item. While the embodiment illustrated in FIG. 5 includes only two queries, a rank circle may contain a plurality of queries, as further illustrated in the figures and described herein.

FIG. 6 is a screen diagram illustrating one embodiment of a rank circle containing a plurality of queries and the plurality of pixels representing content items responsive to the queries at one or more ranks.

The queries 602, 604, and 606 in the rank circle illustrated in FIG. 6 are placed in random order and are not sorted according to any sorting technique. The rank circle illustrates the relevance of the content items responsive to each query at each respective rank, as illustrated by one or more pixels.

As illustrated in FIG. 6, the one or more circles comprising a given rank circle indicate the rank of each content item represented by a pixel. For example, the outermost circle 608 illustrated in FIG. 6 comprises the one or more content items responsive to the one or more queries on the rank circle at rank one (“1”). Similarly, the third outermost circle 610 comprises the one or more content items responsive to the one or more queries on the rank circle at rank three (“3”).

The pixels 620 and 630 representing content items responsive to each query in the rank circle are colored either green or red. According to one embodiment of the present invention, a green pixel 630 comprises a pixel representing a content item that is considered relevant with respect to a given query, whereas a red pixel 620 comprises a pixel representing a content item that is considered irrelevant with respect to a given query.

While the rank circle illustrated in FIG. 6 depicts the use of two colors to indicate the relevance of content items with respect to one or more queries, those of skill in the art recognize the plurality of techniques that may be used to indicate the relevance of content items represented by pixels with respect to one or more queries. For example, as previously described, pixels representing content items may contain patterns or symbols indicating the relevance of the content items represented by the pixels with respect to a given query. Alternatively, or in conjunction with the foregoing, a plurality of colors may be used to indicate varying degrees of relevance. For example, the colors, red, orange, yellow, blue, and green may be used to indicate varying levels of relevance, wherein red indicates “Irrelevant,” orange indicates “Mostly irrelevant,” yellow indicates “Somewhat relevant,” blue indicates “Relevant,” and green indicates “Highly Relevant.”

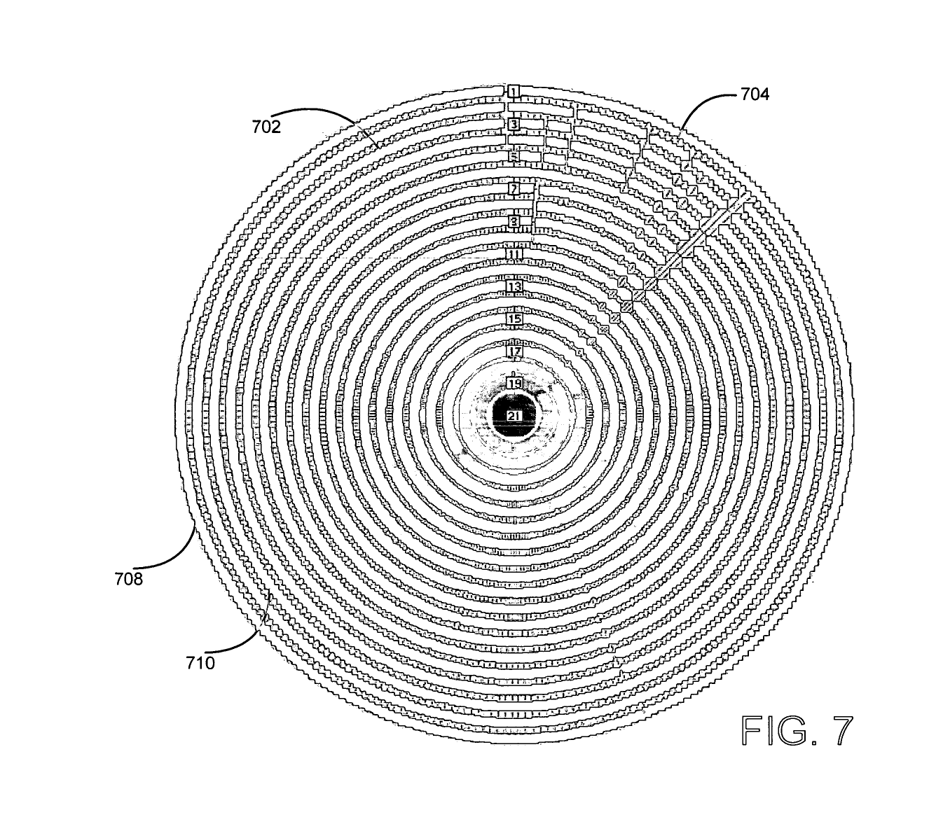

FIG. 7 illustrates one embodiment of a rank circle with a plurality of queries sorted according to given rank circle sorting technique. Sorting a given rank circle in which content items are ranked according to a ranking function provides a visualization of the degree to which items ranked by a ranking function are relevant or irrelevant.

The queries in the rank circle illustrated in FIG. 7 are sorted according to relevance and descending rank. Sorting according to relevance and descending rank comprises first sorting the one or more queries in the rank circle with responsive content items represented by pixels at rank one (“1”) based upon relevance. For example, as illustrated in the rank circle in FIG. 7, the queries with pixels representing content items that are considered relevant at rank one (“1”) 708, as indicated by the color green, are sorted counter-clockwise. Thereafter, the queries with pixels representing content items that are considered relevant at rank two (“2”) 710 are sorted counter-clockwise. The sorting of the ranking circle based upon relevance may be performed for each respective rank within the rank circle. The sorted rank circle provides a visualization of the degree to which items ranked by the ranking function are relevant or irrelevant with respect to the one or more queries.

As previously described, modifications may be made to a ranking function that is used to rank content items responsive to the one or more queries in a given rank circle. For example, a content provider may wish to determine the way in which one or more changes to a ranking function impact the effectiveness of the ranking function. Accordingly, the content provider may modify the ranking function and thereafter generate a revised ranking circle, which provides a visualization of the effectiveness of the modified ranking function. The content provider may perform a comparison of the one or more rank circles generated using one or more ranking functions in order to identify the ranking function that provides the most effective ranking of content items responsive to one or more queries.

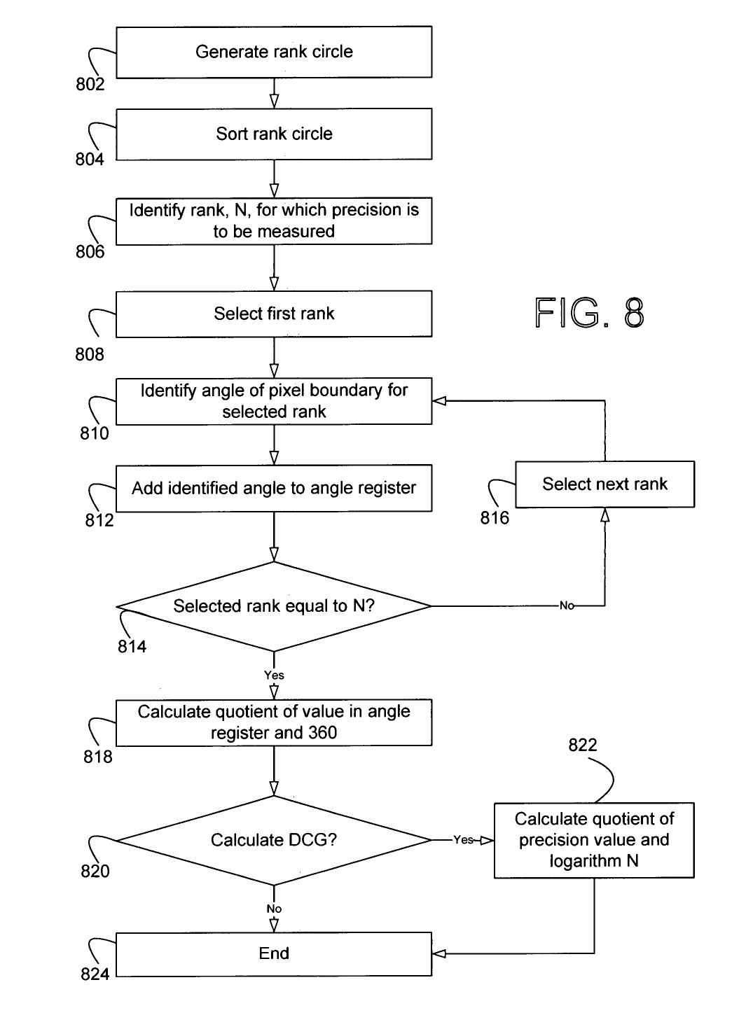

FIG. 8 illustrates one embodiment of a method of determining the precision of a given ranking function used to rank one or more content items represented by pixels in a given sorted rank circle. According to the embodiment illustrated in FIG. 8, a rank circle is generated, step 802, and sorted, step 804, according to methods described herein. A given rank, “N,” for which the precision of the ranking function used to rank the content items at the selected rank is selected, step 806.

The first rank in the rank circle is selected from among the one or more ranks, step 808. The angle of the pixel boundary at the selected rank is identified, step 810. According to one embodiment of the present invention, the pixel boundary at a given rank comprises the first location at which a pixel at the given rank changes from a first color to a second color. According to another embodiment of the present invention, the pixel boundary at a given rank comprises the first location at which a pixel at the given rank changes from a first pattern or symbol to a second pattern or symbol.

The identified angle of the pixel boundary at the selected rank is added to the value in an angle register, wherein the angle register may comprise a register operative to maintain a numerical value, step 812. According to the embodiment illustrated in FIG. 8, a check is performed to determine whether the selected rank is equal to the identified rank “N,” step 814. If the selected is not equal to the identified rank “N,” the next rank in the rank circle is selected, step 816.

If the selected rank is equal to the identified rank “N,”, the quotient of the value maintained in the angle register and the numerical value “360” is calculated, step 818. The calculated quotient yields the precision of the ranking function used to rank the one or more content items represented by pixels in the rank circle at the identified rank

The precision value calculated through use of the method illustrated in FIG. 8 may further be used to determine the discounted cumulative gain (“DCG”) for the one or more content items at a given rank in a rank circle. According to the embodiment illustrated in FIG. 8, a check is performed whether the DCG for the identified rank “N” is to be calculated, step 820. If the DCG is to be calculated for the identified rank “N,” the quotient of the precision value at rank “N” and logarithm “N” is calculated, step 822. The calculated quotient yields the DCG at the identified rank “N.” If the DCG is not to be calculated for rank “N,” or after the DCG has been calculated for rank “N,” processing terminates, step 824.

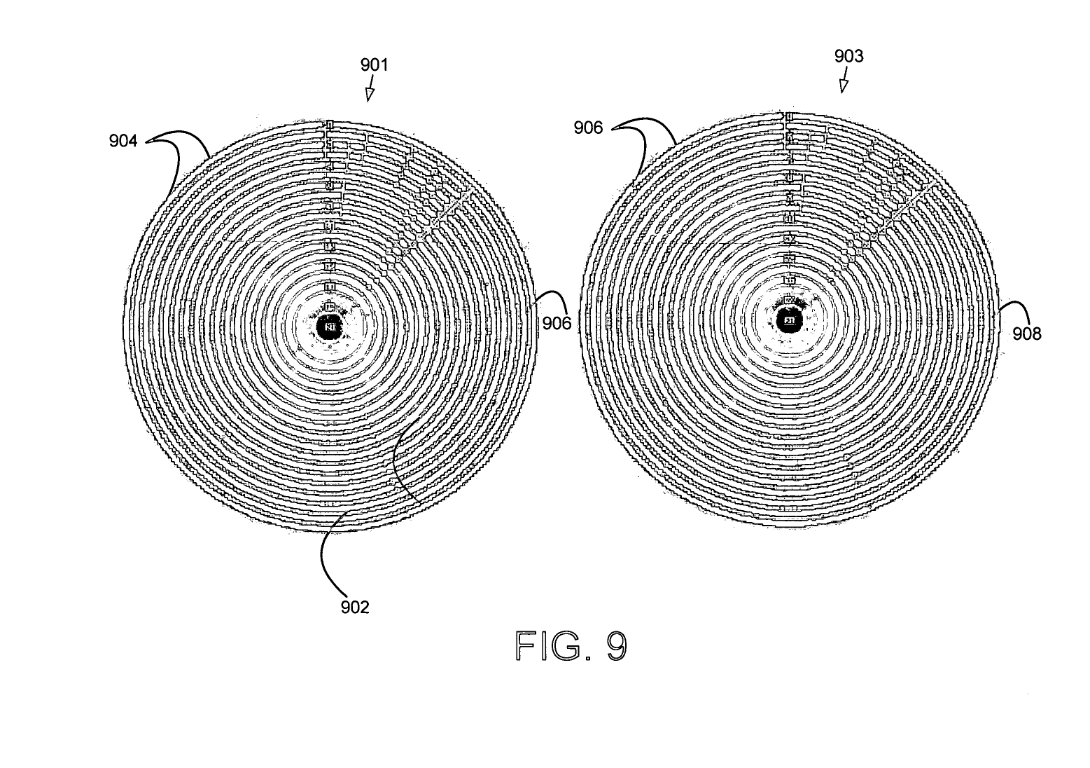

FIG. 9 is a screen diagram illustrating one embodiment of for performing a comparison between a first and a second rank circles containing content items, represented by pixels, ranked through use of different ranking functions. According to the screen diagram illustrated in FIG. 9, a first rank circle 901 is generated for a plurality of queries and one or more responsive content items, which are ranked according to a ranking function. A second rank circle 903 is generated for the one or more queries and the one or more responsive content items, which are ranked according to a modified version of the ranking function.

A comparison may be performed with respect to the first 901 and second 903 rank circles in order to identify differences resulting from use of the original and modified version of the ranking function, respectively. For example, region 906 of rank circle 901 contains several pixels representing content items that are colored red, indicating that the content items are not relevant with respect to a given query. In contrast, the corresponding pixels in region 908 of rank circle 903 are colored green, indicating that the content items are relevant with respect to the one or more queries. Similarly, pixels 904 in rank circle 901 are colored green, indicating that the content items represented by the pixels are relevant with respect to the one or more queries at a given rank, whereas the corresponding pixels 906 in rank circle 903 are colored red, indicating that the content items represented by the pixels are irrelevant with respect to the one or more queries at the given rank.

A comparison performed with respect to a first rank circle 901 and second rank circle 903 provides a visual indication of the way in which one or more modifications made with respect to a given ranking function impact the precision of the ranking function.

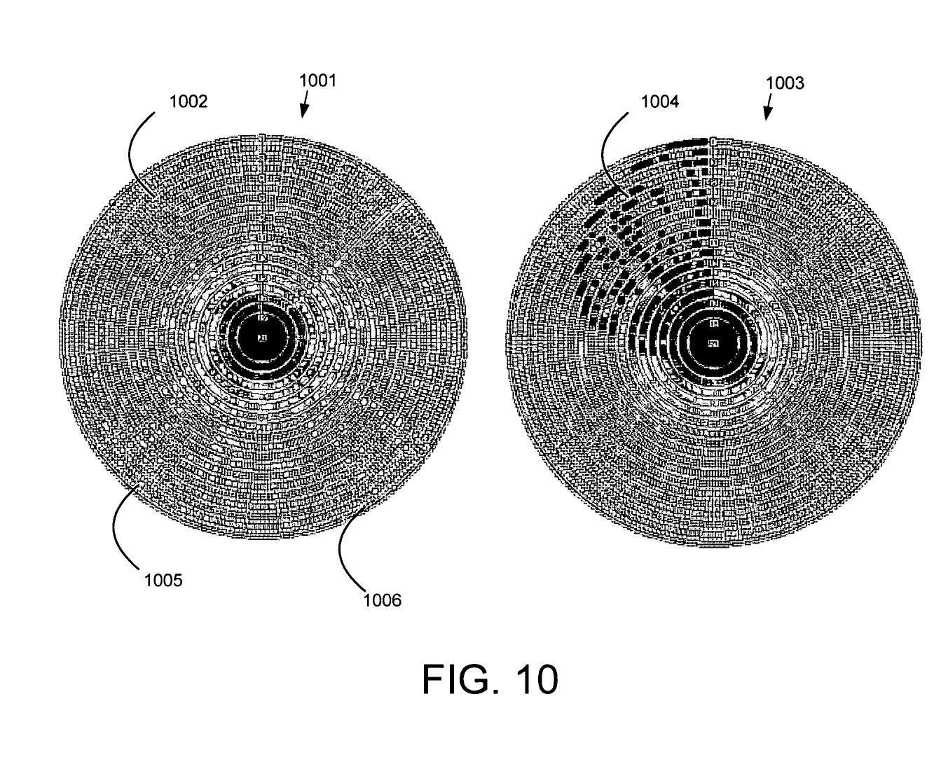

FIG. 10 is a screen diagram illustrating one embodiment for providing a visual representation of the difference between a first rank circle containing pixels representing content items ranked according to a ranking function, and a second rank circle containing pixels representing content items ranked according to a modified version of the ranking function. Rank circle 1001 provides an unsorted visualization of the differences between rank circles 901 and 903 illustrated in FIG. 9. The pixels appearing in red and green indicate pixels that differ between the rank circles 901 and 903 illustrated in FIG. 9. The pixels that are not colored indicate pixels that are the same with respect to the rank circles 901 and 903 illustrated in FIG. 9. For example, as illustrated in rank circle 1001, pixels 1005 and 1006 are red and green respectively, indicating that such pixels are different between rank circles 901 and 903 illustrated in FIG. 9. In contrast, pixel 1002 is not colored, and accordingly, indicates that the pixel is the same with respect to rank circle 901 and 903 illustrated in FIG. 9.

Rank circle 1003 illustrated in FIG. 10 provides a sorted version of rank circle 1001. More specifically, the pixels illustrated in rank circle 1001, which indicate the differences between rank circles 901 and 903 illustrated in FIG. 9, are sorted in order to provide a visualization of the degree to which rank circles 901 and 903 illustrated in FIG. 9 differ. As previously described, rank circle 901 illustrated in FIG. 9 is generated using a ranking function and rank circle 903 illustrated in FIG. 9 is generated using a modified version of the ranking function. The sorted rank circle 1003 illustrated in FIG. 10 provides a visualization of the extent to which the modifications to the ranking function used to generate rank circles 901 and 903 impact the precision of the ranking function.

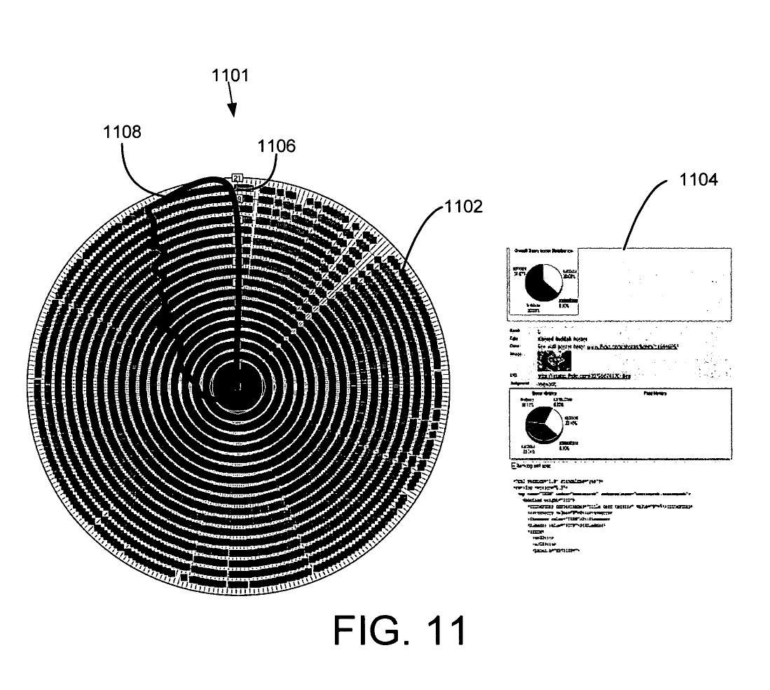

FIG. 11 is a screen diagram illustrating one embodiment of a rank circle in which a user may select one or more regions to gain additional information regarding the content items, represented by pixels, in the rank circle. As previously described, a rank circle may be generated for one or more queries, identifying the content items, which are represented by pixels in the rank circle, that are responsive to the one or more queries at one or more ranks. While a given pixel within the rank circle indicates the degree to which the content item represented by the pixel is relevant with respect to a given query, a user may wish to ascertain additional information regarding the content item represented by the pixel.

According to the embodiment illustrated in FIG. 11, a user may use a selection device, such as a mouse or a keyboard, to select a given pixel 1102 of a rank circle 1101. Selection of a pixel in a rank circle 1101 may result in the display of additional information 1104 regarding the content item represented by the pixel. According to one embodiment of the present invention, the additional information 1104 presented to a user upon selection of a given pixel 1102 in a rank circle 1101 comprises the content item represented by the selected pixel 1102. For example, a given pixel 1102 may represent a website page responsive to a given query. Selection of the pixel 1102 representing the website page may result in display of the website page 1104. Similarly, selection of the pixel 1102 representing a website page may result in the display of a Uniform Resource Locator (“URL”) to the website page.

According to another embodiment of the present invention, a user may select a query 1106 in the rank circle 1101. As described, a rank circle contains one or more queries and the content items, represented by pixels, responsive to the one or more queries. A user may select a query in the rank circle, which may result in additional information 1104 being presented to the user regarding the selected query 1106. According to one embodiment of the present invention, upon selection of a query 1106, a user is presented with statistics 1104 regarding the query 1106. For example, upon selection of a given query 1106, a user may be presented with statistics or other information 1104 regarding the degree to which content items represented by pixels in the rank circle are relevant with respect to the query. Similarly, upon selection of a given query 1106, a user may be presented with information 1104 indicating the types of content items responsive to the selected query. Alternatively, or in conjunction with the foregoing, selection of a given query by a user may result in the presentation of additional information 1104 regarding the ways in which the query is similar or dissimilar to the one or more additional queries in the rank circle 1101.

According to the embodiment illustrated in FIG. 11, a user may also select a region 1108 within a given rank circle in order to obtain additional information regarding one or more queries and/or one or more content items represented by pixels contained within the selected region 1108. For example, using a selection device such as a mouse, a user may select a given region 1108 within the rank circle 1101. Upon selection of the region 1108, the user may be presented with additional information 1104 regarding the plurality of queries selected, such as the type of queries, the average number of words comprising the one or more queries, common terms appearing in the one or more queries, etc. Alternatively, or in conjunction with the foregoing, upon selection of the region 1108, the user may be presented with additional information 1104 regarding the content items represented pixels contained within the selected region, such as statistics regarding the types of content items, thumbnails illustrating the content items, statistics regarding the relevance of the selected content items, etc.

FIGS. 1 through 10 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for generating a visual representation indicating performance of a system capable of accepting one or more inputs and producing an ordered set of one or more responsive outputs, the method comprising:
selecting one or more benchmark inputs;
generating an ordered output set for each of the one or more benchmark inputs, a given output set comprising one or more output items responsive to a given benchmark input;
generating one or more pixels representing the one or more output items comprising the one or more output sets, a given pixel containing a visual representation indicating a degree to which the output item represented by the pixel is relevant with respect to the benchmark input to which the output item is responsive;
arranging the one or more pixels representing the one or more output items comprising the one or more output sets in a circle in a manner indicative of the performance of the system; and
storing the circle on a data storage device.

2. The method of claim 1 wherein the system comprises a search engine.

3. The method of claim 2 wherein selecting one or more benchmark inputs comprises selecting one or more benchmark queries generated by users of the search engine.

4. The method of claim 3 wherein generating an ordered output set comprises:
identifying one or more content items responsive to one or more selected benchmark queries; and
generating an ordered output set for each of the one or more benchmark inputs, a given output set comprising the one or more content items responsive to a given benchmark query.

5. The method of claim 4 wherein identifying one or more content items responsive to one or more selected benchmark queries comprises identifying one or more web pages responsive to the one or more benchmark queries.

6. The method of claim 4 wherein identifying one or more content items responsive to one or more selected benchmark queries comprises identifying one or more documents responsive to the one or more benchmark queries.

7. The method of claim 4 wherein identifying one or more content items responsive to one or more selected benchmark queries comprises identifying one or more audio content items responsive to the one or more benchmark queries.

8. The method of claim 4 wherein identifying one or more content items responsive to one or more selected benchmark queries comprises identifying one or video content items responsive to the one or more benchmark queries.

9. The method of claim 1 wherein generating an ordered output set comprises generating an ordered output set through use of a ranking function.

10. The method of claim 9 wherein arranging the one or more pixels representing each of the output items comprises:
arranging the one or more pixels representing each of the output items along one or more lines according to a rank associated with the one or more output items as determined by the ranking function, a given line associated with a given output set; and
arranging the one or more lines associated with the one or more output sets in a circle.

11. The method of claim 10 wherein arranging the one or more lines associated with the one or more output sets in a circle comprises arranging the one or more lines in a three dimensional circle.

12. The method of claim 10 further comprising sorting the one or more lines associated with the one or more output sets through use of a sorting algorithm.

13. The method of claim 1 wherein generating a pixel representing a content item comprises generating a three dimensional pixel.

14. The method of claim 1 wherein generating a pixel representing an output item comprises:
identifying a degree to which the output item is relevant with respect to the benchmark input to which the output item is responsive; and
generating a pixel containing a visual representation indicative of the degree to which the output item is relevant with respect to the benchmark input.

15. The method of claim 14 wherein generating a pixel containing a visual representation indicative of the degree to which the output item is relevant with respect to the benchmark input comprises generating a colored pixel, the color of the pixel indicative of the degree to which the output item represented by the pixel is relevant with respect to the benchmark input

16. The method of claim 14 wherein generating a visual representation indicative of the degree to which the output item is relevant with respect to the benchmark input comprises generating a pixel containing a pattern, the pattern indicative of the degree to which the output item represented by the pixel is relevant with respect to the benchmark input.

17. The method of claim 14 wherein generating a visual representation indicative of the degree to which the output item is relevant with respect to the benchmark input comprises generating a pixel containing a symbol, the symbol indicative of the degree to which the output item represented by the pixel is relevant with respect to the benchmark input.

18. The method of claim 14 wherein generating a visual representation indicative of the degree to which the output item is relevant with respect to the benchmark input comprises generating a pixel of a given size, the size of the pixel indicative of the degree to which the output item represented by the pixel is relevant with respect to the benchmark input.

19. The method of claim 14 wherein generating a visual representation indicative of the degree to which the output item is relevant with respect to the benchmark input comprises generating a pixel of a given shape, the shape of the pixel indicative of the degree to which the output item represented by the pixel is relevant with respect to the benchmark input.

20. The method of claim 1 further comprising:
receiving an indication of a user selection of a given region in the circle; and
providing information regarding the selected region.

21. The method of claim 20 wherein receiving an indication of a user selection comprises receiving an indication of a user selection of one or more pixels representing one or more output items.

22. The method of claim 21 wherein providing information regarding the selected region comprises displaying the one or more output items represented by the one or more selected pixels.

23. The method of claim 1 further comprising:
arranging the one or more pixels representing the one or more output items comprising the one or more output sets in a first circle, the one or more output items in the one or more output sets ordered according to a ranking function;
performing one or more modifications with respect to the ranking function;
arranging the one or more pixels representing the one or more output items comprising the one or more output sets in a second circle, the one or more output items in the one or more output sets ordered according to the modified ranking function;
performing a comparison between the first circle and the second circle; and
storing one or more data items indicating a result of the comparison.

24. The method of claim 23 wherein performing one or more modifications with respect to the ranking function comprises modifying one or more ways in which the ranking function identifies a ranking for the one or more output items comprising a given output set.

25. The method of claim 23 wherein performing a comparison comprises identifying one or more pixels that differ between the first and second circle.

26. (canceled)
